(19) United States
(12) Patent Application Publication
(10) Pub. No.: US 2023/0033120 A1
(43) Pub. Date: Feb. 2, 2023

(54) Preserving Buildings and Other Assets from Bushfires

(71) Applicant: EPS INVESTMENTS AUSTRALIA PTY LTD, Rouse Hill (AU)

(72) Inventor: Geoffrey James Sprod, Annangrove (AU)

(73) Assignee: EPS INVESTMENTS AUSTRALIA PTY LTD, Rouse Hill (AU)

(21) Appl. No.: 17/955,196

(22) Filed: Sep. 28, 2022

Related U.S. Application Data
(63) Continuation-in-part of application No. 15/883,579, filed on Jan. 30, 2018, now abandoned.

(30) Foreign Application Priority Data
Jul. 6, 2017 (AU) 2017902650

(51) Int. Cl. A62C 3/02

(52) U.S. Cl. CPC A62C 3/0242; A62C 3/0214

(57) ABSTRACT

A method of preserving a building or similar asset (16) from destruction by a bushfire is disclosed. The method includes the step of shortly prior to the arrival of the bushfire at the asset or building (16), spraying the exterior of said asset or building (16) with a water-based fire retardant (17) ejected from a nozzle (10) located above the asset or building (16) and mounted on a helicopter (1) carrying the water-based fire retardant (17).

### FIELD OF THE INVENTION

The present invention relates to the preservation of buildings and assets and also to bushfires.

### BACKGROUND OF THE INVENTION

Bushfires, (or wildfires as they are sometimes called in some jurisdictions), are capable of causing enormous damage including loss of human life, destroying of buildings and other infrastructure by fire, and destruction of native animal habitat. For example, each year Australia's insurance companies pay out considerable sums of money to enable buildings destroyed by bushfire to be rebuilt and other assets to be replaced.

Fighting bushfires has traditionally been done from the ground utilizing water tankers, pumps and hand directed hoses. In recent years, these traditional methods have been augmented by aircraft dropping water onto the fire itself. Both fixed wing aircraft and helicopters had been used in this endeavor. Sometimes the water dropped has been modified by the addition of fire retardants of various types.

It is known from Australian Patent Applications Nos 2016 203 443 and 2016 213 780 to carry out what is known as “striping” which is the spraying of a fire retardant gel along a strip or ribbon of ground in order to halt the advance of a bushfire. Whilst this can be an effective strategy in many instances, it still leaves buildings and other infrastructure open to destruction, particularly by flying burning particles or otherwise airborne embers moving downwind of the fire front and landing on the roof of a building, and thereby setting fire to the building.

### GENESIS OF THE INVENTION

The Genesis of the present invention is a desire to ameliorate the above-mentioned problems and, in particular, to preserve buildings from being destroyed by bushfires.

### SUMMARY OF THE INVENTION

In accordance with a first aspect of the present invention there is disclosed a method of preserving a building or similar asset from destruction by a bushfire, said method comprising the step of shortly prior to the arrival of said bushfire at said asset or building, spraying the exterior of said asset or building with a water-based fire retardant ejected from a nozzle located above the asset or building and mounted on a helicopter carrying said water-based fire retardant.

According to another aspect of the present invention there is provided a method of preserving a plurality of buildings or similar assets, and thereby ameliorating the destructive effect of a bushfire in destroying or damaging said buildings or similar assets by burning or radiant heat, said bushfire having at least one fire front traveling in a corresponding fire front direction; said method comprising the steps of the method of the first aspect of the present invention performed for each of said plurality of assets or buildings, and wherein the helicopter is flown in said fire front direction and in advance of said fire front, and the spraying of the exterior of each of said plurality of assets or buildings is performed substantially sequentially in said fire front direction.

According to another aspect of the present invention there is provided a method of preserving a multiplicity of buildings, or similar structural assets, from destruction by a bushfire having a fire front, said method comprising the steps of:
(i) flying a helicopter, including at least one tank and having a nozzle mounted on the helicopter and movable in azimuth and elevation, towards a first one of said multiplicity of buildings or assets,
(ii) flying said helicopter in a first loop around said first building or asset whilst spraying a water-based fire retardant from said nozzle so as to spray all of the exterior walls of said first building or asset,
(iii) flying said helicopter away from said fire front and towards a second one of said multiplicity of buildings or assets,
(iv) flying said helicopter in a second loop around said second building or asset whilst spraying a water-based fire retardant from said nozzle so as to spray all of the exterior walls of said second building or asset,
(v) at all times during flying of said helicopter not attempting to extinguish said bushfire, and
(vi) repeating steps (iii)—(v) for third and subsequent buildings or assets until substantially all of said water-based fire retardant has been sprayed from said nozzle.

Preferably, following step (vi) the helicopter is flown away from the fire front to a location where the water-based fire retardant can be replenished, the helicopter is flown towards an unsprayed building or asset adjacent the fire front, and step (vi) is repeated, all the while not attempting to extinguish the bushfire.

### BRIEF DESCRIPTION OF THE DRAWINGS

Preferred embodiments of the invention will now be described, by way of example only, with reference to the accompanying drawings in which:

FIG. 1 is a perspective view of the starboard side of a building preservation equipped helicopter in accordance with a preferred embodiment of the present invention,

FIG. 2 is a perspective view of the port side of the helicopter of FIG. 1,

FIG. 3 is a schematic block diagram of the fluid circuit mounted on the helicopter of FIG. 1, and

FIG. 4 is an elevation diagram of the helicopter of FIGS. 1 and 2 when applying a fire-retardant gel to a residential building

### DETAILED DESCRIPTION OF THE PREFERRED EMBODIMENTS

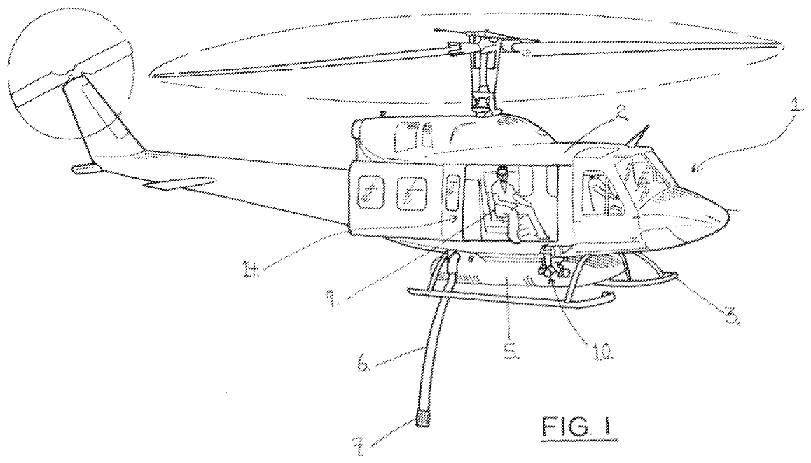

As seen in FIG. 1, a helicopter 1 having a main body 2 and landing skids 3 is equipped with a water tank 5 which takes the form of a belly tank. In known fashion a flexible snorkel tube 6 depends from the water tank 5 and at its lower end has a housing 7 which contains a filter and an electrically operated filler pump (not illustrated). The water tank 5 holds approximately 1600 L and is able to be refilled by means of the helicopter 1 hovering above a dam, tank, or similar water reservoir (not illustrated).

Mounted on the main body 2 of the helicopter 1 is a nozzle 10 controlled by an operator 9. Located within the main body 2 of the helicopter 1 is an auxiliary fuel tank which does not hold fuel but instead holds a fire retardant gel concentrate. The volume of this gel tank 14 is approximately 300 L. The gel is that disclosed in U.S. Pat. Nos. 5,989,446 and 6,245,252, the contents of which are hereby incorporated in their entirety by cross-reference. The gel is commercially available from Thermo Technologies, LLC of Bismarck, Nev. USA.

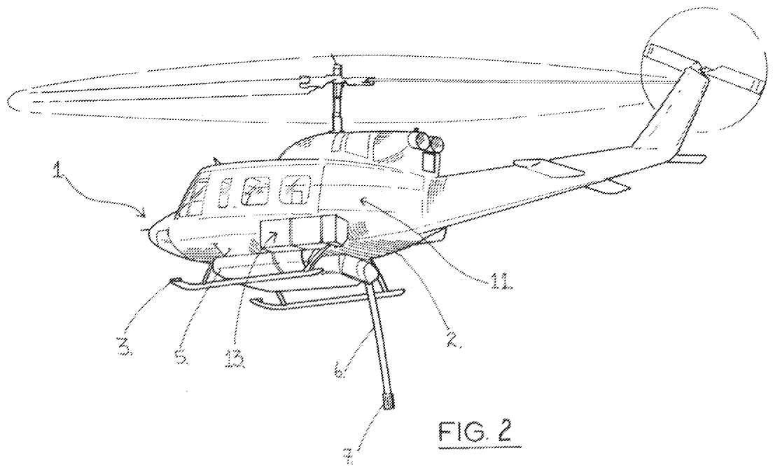

As seen in FIG. 2, mounted alongside the body 2 of the helicopter 1 is a main pump 13 for providing water pressure to the nozzle 10 (FIG. 1). A proportioner 11 is also provided within the helicopter 1 for controlling the concentration of gel fed to the nozzle 10.

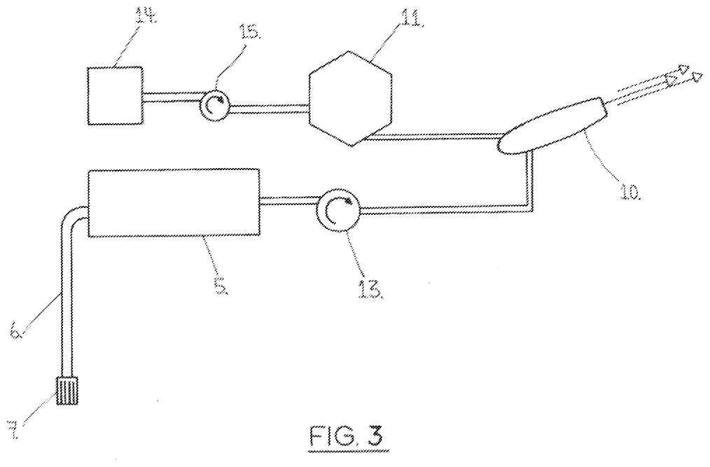

As seen in FIG. 3, the gel tank 14 has its outlet connected to an electrical gel pump 15 which is connected to the proportioner 11. The water tank 5 with its snorkel tube 6 has its outlet connected to the main pump 13. The main pump 13 has an outlet which is connected to the nozzle 10. The proportioner 11 is also connected to the nozzle 10 and the pumps 13, 15 are operated so that a predetermined portion of the gel concentrate is entrained with the water from the water tank 5. Preferably the concentration of gel leaving the nozzle 10 is in the vicinity of 1.5%-2% by volume. An operator 9 (FIG. 1) is able to control the gel concentration. In addition, the nozzle 10 is preferably steerable through a wide arc of azimuth and elevation and thus the operator 9 is also able to control the direction in which the nozzle 10 points. Furthermore, the operator 9 is also preferably able to change the configuration of the liquid ejected from the nozzle 10 from a narrow stream to a wide spray.

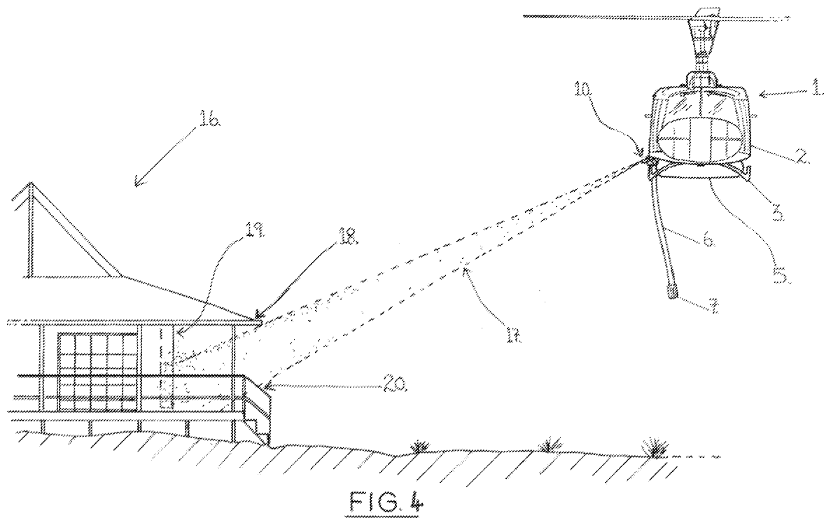

As seen in FIG. 4, when in operation, the helicopter 1 does not attempt to extinguish the actual fire or fire front (not illustrated). Instead, the helicopter 1 is flown in advance of the fire front, and from a height of typically 20 meters or so, is used to spray the roof 18, walls 19, verandahs 20 etc. of buildings 16 in the potential path of the fire with the fire retardant gel 17. In this manner and with its low-flying capability, the helicopter 1 when applying the gel 17 is able to mimic the angles or mean angle of radiant heat, embers, etc. as emitted from a flame zone toward the asset or building 16 (for example of about 20 to 45 degrees downwardly from the horizontal). The fire retardant gel 17 has the property that it renders the building 16 essentially incombustible for a period of 6-7 hours by which time the fire has either been put out, or has passed by the building 16. In either case the building 16 has not burnt.

There are two important aspects to this spraying operation. The first is that the operation is quite quick and a typical cottage 16 would take less than 3-4 minutes to be provided with an adequate spray coverage of the gel 17. If an average of 600 L of gel 17 is applied to each house 16, a total of 2-3 houses 16 can be sprayed with one water tank 5 full of water. Similarly, each house 16 consumes approximately 15 L of gel concentrate. Thereafter the water tank 5 can be replenished utilizing the snorkel tube 6 and a dam (not illustrated), for example, adjacent the fire front. As a consequence, the helicopter 1 can make numerous sorties on a single tank 14 of gel concentrate. Typically 9 or 10 water tank loads are required to empty the gel tank 14. Thereafter the helicopter 1 has to retire to a rural fire shed or similar base (not illustrated), in order to re-fill the gel tank 14 (and normally the water tank 5 also). Thereafter this cycle is able to be repeated.

Another important aspect to the spraying operation is that the helicopter 1 and nozzle 10 can be used in concert to spray all of the walls 19, and any verandas 20 or door alcoves (not illustrated) etc. of the building 16. This is to be contrasted with a fixed wing aircraft which, whilst it can dump water containing fire retardant on a building, because of the substantial ground speed of the fixed wing aircraft, the water has a substantial horizontal speed component and thus must inherently leave the downstream wall of the building un-wetted. Similarly various door alcoves and verandas will also be un-wetted because of the trajectory of the water falling from a fixed wing aircraft.

Thus there is disclosed a method of preserving a building or similar asset 16 from destruction by a bushfire, the method comprising the step of shortly prior to the arrival of the bushfire at the asset or building 16, spraying the exterior of the asset or building 16 with a water-based fire retardant 17 ejected from a nozzle 10 located above the asset or building 16 and mounted on a helicopter 1 carrying the water-based fire retardant 17.

Similarly, the destructive effect of bushfires in destroying assets or buildings 16 by burning can be ameliorated by the disclosed method of flying a building preservation equipped helicopter (1; as described above) in a direction in advance of the fire front, and sequentially spraying the exterior of each of a multiplicity of assets or buildings 16 with a water-based fire retardant 17 ejected from a nozzle 10 carried by the helicopter 1 and positioned in turn above each of the assets or buildings 16.

It is to be understood that the reference to “buildings” above refers not only to houses and cottages, but also to other buildings such as schools, churches, machinery sheds, milking sheds, stables, transformer enclosures, and like. Similarly, other assets including power poles, telephone towers, caravans, headers and tractors can also be protected. These assets or buildings are usually not more than a few storeys in height.

The foregoing describes only one embodiment of the present invention and modifications, obvious to those skilled in the building preservation arts, can be made thereto without departing from the scope of the present invention.

The term “comprising” (and its grammatical variations) as used herein is used in the inclusive sense of “including” or “having” and not in the exclusive sense of “consisting only of”.

Claims:

1. A method of preserving a building or similar asset from destruction by a bushfire, said method comprising the step of shortly prior to the arrival of said bushfire at said asset or building, spraying the exterior of said asset or building with a water-based fire retardant ejected from a nozzle located above the asset or building and mounted on a helicopter carrying said water-based fire retardant.

2. The method as defined in claim 1 wherein the height above ground level of said helicopter whilst spraying is in the vicinity of approximately 20 meters.

3. The method as defined in claim 1 wherein the nozzle can be reoriented in both elevation and azimuth relative to the helicopter for controlling a sprayed direction of the nozzle ejecta.

4. The method as defined claim 1 wherein the asset or building includes at least a first and second exterior surfaces sprayable from substantially different sides of the asset or building, and the method further comprises the step of maneuvering the helicopter about the different sides to spray each of the first and second exterior surfaces with the fire retardant.

5. The method as defined in claim 1 wherein the asset or building has a perimeter that is susceptible to attack by radiant heat, flames, or embers emitted from the bushfire, and the method further comprises the step of maneuvering the helicopter substantially in an arc about the susceptible perimeter whilst spraying the exterior of the asset or building with the fire retardant.

6. The method as defined in claim 1 wherein the sprayed exterior of the building includes the roof of the building.

7. The method as defined in claim 1 wherein the sprayed exterior of the building includes the side walls of the building.

8. The method as defined in claim 1 wherein the sprayed exterior of the building includes recesses in the sides of the building including door alcoves and verandahs.

9. A method of preserving a plurality of buildings or similar assets, and thereby ameliorating the destructive effect of a bushfire in destroying or damaging said buildings or similar assets by burning or radiant heat, said bushfire having at least one fire front traveling in a corresponding fire front direction; said method comprising the step(s) of the method as defined in claim 1 performed for each of said plurality of assets or buildings, and wherein the helicopter is flown in said fire front direction and in advance of said fire front, and the spraying of the exterior of each of said plurality of assets or buildings is performed substantially sequentially in said fire front direction.

10. The method as defined in claim 9 including the steps of sequentially spraying the exterior of each of the assets or buildings of a first sequence of assets or buildings to thereby empty the water tank of the helicopter, refilling the water tank of the helicopter, and sequentially spraying the exterior of each of the assets or buildings of a second sequence of assets or buildings.

11. The method as defined in claim 1, wherein the step of spraying all of the exterior walls of said asset or building with a water-based fire retardant ejected from a nozzle located above the asset or building and mounted on a helicopter includes spraying the fire-retardant at an angle between 20° and 45° downwardly from horizontal.

12. A method of preserving a multiplicity of buildings, or similar structural assets, from destruction by a bushfire having a fire front, said method comprising the steps of:
(i) flying a helicopter, including at least one tank and having a nozzle mounted on the helicopter and movable in azimuth and elevation, towards a first one of said multiplicity of buildings or assets,
(ii) flying said helicopter in a first loop around said first building or asset whilst spraying a water-based fire retardant from said nozzle so as to spray all of the exterior walls of said first building or asset,
(iii) flying said helicopter away from said fire front and towards a second one of said multiplicity of buildings or assets,
(iv) flying said helicopter in a second loop around said second building or asset whilst spraying a water-based fire retardant from said nozzle so as to spray all of the exterior walls of said second building or asset,
(v) at all times during flying of said helicopter not attempting to extinguish said bushfire, and
(vi) repeating steps (iii)-(v) for third and subsequent buildings or assets until substantially all of said water-based fire retardant has been sprayed from said nozzle.

13. The method as defined in claim 12 wherein the height above ground level of said helicopter whilst spraying is in the vicinity of approximately 20 meters.

14. The method as defined in claim 13 wherein the sprayed exterior of the building or asset includes a roof of the building or asset.

15. The method as defined in claim 14 wherein the sprayed exterior of the building or asset includes the side walls of the building.

16. The method as defined in claim 15 wherein the sprayed exterior of the building or asset includes recesses in the sides of the building or asset including door alcoves and verandahs.

17. The method as defined in claim 16 wherein following step (vi) the helicopter is flown away from the fire front to a location where the water-based fire retardant can be replenished, the helicopter is flown towards an unsprayed building or asset adjacent the fire front, and step (vi) is repeated, all the while not attempting to extinguish the bushfire.
